(19) United States
(12) Patent Application Publication
(10) Pub. No.: US 2019/0134685 A1
(43) Pub. Date: May 9, 2019

(54) SOLAR FARMS FOR ENVIRONMENTAL REMEDIATION OF BROWNFIELD SITES

(71) Applicant: PATRICK KEHOE, ORILLIA (CA)

(72) Inventor: PATRICK KEHOE, ORILLIA (CA)

(21) Appl. No.: 16/182,165

(22) Filed: Nov. 6, 2018

Related U.S. Application Data
(60) Provisional application No. 62/581,871, filed on Nov. 6, 2017.

(51) Int. Cl. B09C 1/00; H02J 3/38; H02J 3/00

(52) U.S. Cl. CPC B09C 1/00; H02J 3/383; H02J 3/386; C25B 1/04; B09C 2101/00; B09C 1/002; H02J 3/008

(57) ABSTRACT

A bioremediation method is disclosed. Power generation equipment for generating renewable power is located on a brownfield site. Power produced by the power generation equipment is used to power remediation equipment for remediating at least an area of the site. The generated power may also be sold back to the power grid.

### CROSS-REFERENCE TO RELATED APPLICATIONS

This application claims the benefit of U.S. Provisional Patent Application Ser. No. 62/581,871 filed on Nov. 6, 2017, and incorporates said provisional application by reference into this document as if fully set out at this point.

### BACKGROUND OF THE INVENTION

### 1. Field of the Invention

This invention relates to environmental remediation, including methods for remediating brownfield sites.

### 2. Description of the Related Art

Brownfield land includes land that has been contaminated, for example by previous industrial use or other pollution. The types of contaminants on brownfield land include petroleum hydrocarbons, metals and other inorganics. According to Environment Canada, brownfield is defined as abandoned, idle or underutilized commercial or industrial properties where past actions have caused environmental contamination, but which still have potential for redevelopment or other economic opportunities. The Federal Contaminated Sites Inventory of Canada, currently lists over 23,000 federal brownfield sites in Canada, including over 5,000 active contaminated sites. According to the U.S. Environmental Protection Agency, brownfield is defined as a property, the expansion, redevelopment or reuse of which may be complicated by the presence or potential presence of a hazardous substance, pollutant, or contaminant. It is estimated that there are currently more than 450,000 brownfield sites in the U.S.

It is desirable to remediate the brownfield site to enable it to be returned to economical use. Many governments have programs to promote and assist in remediation of brownfield sites. However, it is often uneconomical to remediate the brownfield site because the cost of remediation is more than the expected value of the land after remediation and redevelopment. It would be desirable to provide a way to remediate brownfield sites that are conventionally considered to be uneconomical to remediate.

Before proceeding to a detailed description of the invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

In general, in an exemplary aspect, the invention relates to methods for remediating brownfield sites, where locating a renewable power source on the brownfield site prior to and/or during the remediation helps to mitigate the costs of remediation and helps to make remediation economically feasible.

In a first aspect, the invention provides a bioremediation method. The method includes locating power generation equipment for generating renewable power on a brownfield site. The method also includes remediating at least an area of the brownfield site, using power from the power generation equipment. The method also includes relocating at least a portion of the power generation equipment for the remediation of another area of brownfield.

The power generation equipment may include a photovoltaic cell or a windmill.

The power generation equipment may provide power to only a small portion of the brownfield site, and the power may be used to power remediation equipment located in the small portion of the brownfield site.

In some examples, the method may also include selling at least a portion of the generated power back to a power grid.

In some examples, the method may also include drilling one or more holes to install a support for the power generation equipment. The one or more holes may be useable as a well for the remediation of the brownfield site.

There may also be monitoring equipment connected to the power generation equipment for monitoring efficacy of the remediation over at least the area of the brownfield site.

In some examples, the method may also include monitoring the efficacy of the remediation, and reprogramming remediation equipment to improve the efficacy of the remediation, based on the monitoring.

In a second aspect, the invention provides a bioremediation system. The system includes power generation equipment for generating renewable power located on a brownfield site, and remediation equipment for remediating at least an area of the brownfield site, the remediation equipment using power from the power generation equipment for performing the remediating.

The power generation equipment may include a photovoltaic cell or a windmill.

The power generation equipment may provide power to only a small portion of the brownfield site, and the power may be used to power remediation equipment located in the small portion of the brownfield site.

The power generation equipment may be further connected to a power grid to sell at least a portion of the generated power back to the power grid.

One or more holes for installing a support for the power generation equipment may be also useable as a well for the remediation of the brownfield site.

In some examples, the system may also include monitoring equipment connected to the power generation equipment for monitoring efficacy of the remediation over at least the area of the brownfield site.

The foregoing has outlined in broad terms some of the more important features of the invention disclosed herein so that the detailed description that follows may be more clearly understood, and so that the contribution of the instant inventors to the art may be better appreciated. The invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 is a flowchart illustrating an example bioremediation method, in accordance with an example embodiment; and

FIG. 2 is a diagram illustrating the example method of FIG. 1.

Similar reference numerals may have been used in different figures to denote similar components.

### DETAILED DESCRIPTION OF THE INVENTION

While this invention is susceptible of embodiment in many different forms, there is shown in the drawings, and will herein be described hereinafter in detail, some specific embodiments of the instant invention. It should be understood, however, that the disclosure is to be considered an exemplification of the principles of the invention and is not intended to limit the invention to the specific embodiments or algorithms so described.

Although it is desirable to remediate brownfield sites, it is often uneconomical to do so. Further, even at brownfield sites where remediation is economically feasible, it is often desirable to lower the cost of remediation, to lessen the burden on a government's budget and/or to motivate more remediation efforts. Part of the challenge of remediation is that the economic benefits of remediation are often far in the future, after the site has been fully remediated to acceptable standards and has been redeveloped. This means that a company that takes on a remediation project is taking on a long-term investment, which can be high risk (e.g., if contamination is found to be greater than expected). In various examples, the present disclosure provides a way for the brownfield site to be used to potentially general income, before the site is fully remediated.

Solar farms (also referred to as solar parks or solar fields) are the large-scale application of solar photovoltaic (PV) cells to generate green, clean electricity at scale, usually to feed into the power grid. Solar farms may refer to an array or grid of interconnected (networked) PV cells that generate renewable power (usually DC power, which may be converted to AC power). Solar farms can cover an area between 1 acre to 100 acres or more.

A typical remediation process begins with mapping and assessment of the brownfield site. The assessment includes determining the type and extent of contamination. Normally, a remediation company does not take ownership of the site at this stage.

For the actual remediation, a remediation company may take control of the land (e.g., by leasing or renting the land, or taking the role of property management).

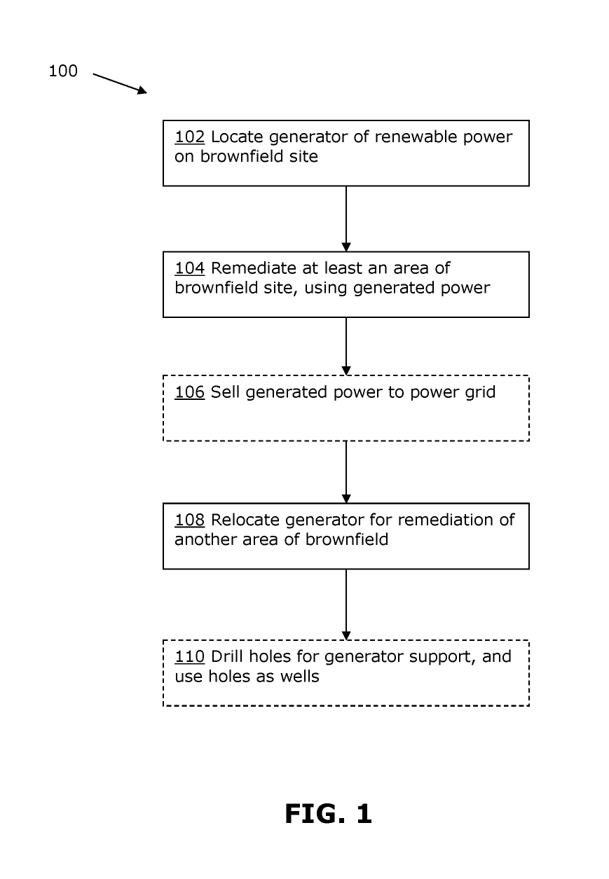

FIG. 1 is a flowchart illustrating an example bioremediation method 100, in accordance with an embodiment of the present disclosure.

At 102, power generation equipment for generation of renewable power is located on a brownfield site. The power generation equipment generates power prior to and/or during remediation of the site. In some cases, at least part of the power generation equipment may also be left on the site after remediation is complete. For example, where remediation of the site takes place by remediating different areas of the site in turn, the power generation equipment may be located on the area currently to be remediated. The power generation equipment may include PV cells (also known as solar cells or solar panels) and/or windmills, for example. The brownfield site may be a suitable site for locating such power generation equipment because the land is generally unused, with little or no obstruction for collection of renewable resources (e.g., sunlight and/or wind) and little or no surrounding residential areas that might be disturbed by the presence of the power generation equipment.

Power generation equipment may be an array of power generators (e.g., an array of PV cells, also referred to as a solar farm) that may cover a large or small area (e.g., 1 acre to 100 acres or more). The power generation equipment may or may not have battery backup.

At 104, remediation of at least an area of the brownfield site is carried out. Any suitable remediation technology may be used, as appropriate for the specific site, including, for example, soil vapor extraction, electrokinetic separation, bioremediation, vapor sparging, ozone oxidization, bioventing, chemical oxidation, in situ biological treatment, in situ thermal treatment, soil flushing and/or pump-and-treat. Power generated by the power generation equipment may be used to power the remediation equipment (e.g., pump, cathodes and other mobile or non-mobile equipment). In this way, the cost of remediation may be reduced.

Where the power generation equipment is a network of power generators (e.g., in the case of a solar farm, a network of interconnected PV cells), space allowances of the power generation equipment installation may allow materials (e.g., oxidants, supplements, etc.) to be introduced centrally to the remediation equipment from other locations. Further, the interconnectivity may also enable the entire area covered by the power generation equipment to be monitored and measured on an ongoing basis (e.g., using monitoring equipment connected to the power generation equipment), for example to determine efficacy of the remedial infrastructure and to reprogram the infrastructure as necessary with the aim of optimum efficacy.

Optionally, at 106, power generated by the power generation equipment may alternatively or additionally be sold back to the power grid, as a source of income for the remediation company and to reduce the overall cost of remediation. In order to sell the power back to the power grid, it may be necessary to establish a contract with a local utility company (e.g., a contract for a defined number of years and a defined rate per kWh).

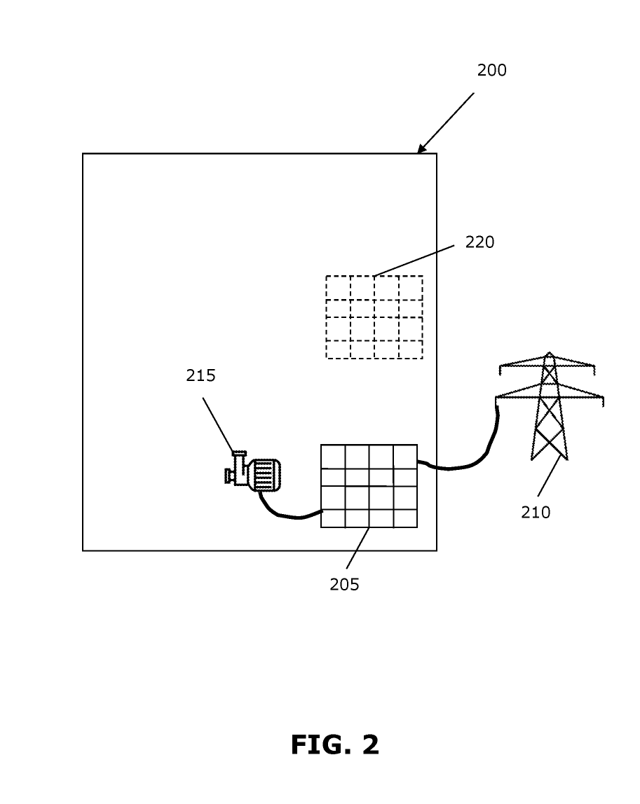

FIG. 2 is a diagram illustrating an array of PV cells 205 installed over an area of a brownfield site 200. The PV cells 205 may be connected to a power grid 210 in order to sell the power. The PV cells 205 may additionally or alternatively be connected to remediation equipment 215.

It is not necessary for the power generation equipment to provide power to the entire area of the site that is being remediated. Having locally produced power at even a corner of the site may be beneficial. For example, such generated power may be used to power non -mobile remediation equipment that is normally placed at only a small corner of the site (e.g., pump).

The power generation equipment may be generally moveable, so that it can be transported to the brownfield site during remediation and moved away when remediation is complete. Further, at least part of the power generation equipment may be moved to different areas of brownfield, whether on the same site or on a different site.

At 108, at least part of the power generation equipment is relocated for the remediation of another area of brownfield. FIG. 2 illustrates that the array of PV cells 205 may be moved to a new location 220, for remediating that area of the brownfield site 200. The PV cells 205 may be reconnected to the power grid 210 after relocation, if appropriate.

Optionally, at 110, when placing the power generation equipment at a new area of the site, one or more holes that are drilled for the support poles of the power generation equipment (e.g., supports for PV cells) may be drilled deeper and used as a well. The well may then be used as part of the remediation process, for example to draw out contaminants through the groundwater. This provides an unexpected synergistic effect.

The example method 100 may be repeated as necessary, over different areas of the site, until the entire brownfield site has been remediated.

The present disclosure provides a bioremediation method brownfield, where an installation of power generation equipment for generating renewable power (e.g., a solar farm) provides power that is used to conduct the on-going remedial initiative. The generated power may also be sold back to a utility at a price guaranteed and protected for the term of the contract. This revenue component may allow the cost of the remedial effort to be reduced significantly, offset entirely or conducted profitably.

The networked remedial infrastructure may be programmed as needed to address subsurface contamination, thus restoring the soil and groundwater to acceptable levels that would permit the reactivation/redevelopment of the lands.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference should not be construed that there is only one of that element.

It is to be understood that where the specification states that a component, feature, structure, or characteristic “may”, “might”, “can” or “could” be included, that particular component, feature, structure, or characteristic is not required to be included.

It is to be understood that were the specification or claims refer to relative terms, such as “front,” “rear,” “lower,” “upper,” “horizontal,” “vertical,” “above,” “below,” “up,” “down,” “top,” “bottom,” “left,” and “right” as well as derivatives thereof (e.g., “horizontally,” “downwardly,” “upwardly” etc.), such reference is used for the sake of clarity and not as terms of limitation, and should be construed to refer to the orientation as then described or as shown in the drawings under discussion. These relative terms are for convenience of description and do not require that the apparatus be constructed or the process to be operated in a particular orientation.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Processes of the instant disclosure may be implemented by performing or completing manually, automatically, or a combination thereof, selected steps or tasks.

The term “process” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a process comprising two or more defined steps, the defined steps can be carried out in any order or simultaneously (except where context excludes that possibility), and the process can also include one or more other steps which are carried out before any of the defined steps, between two of the defined steps, or after all of the defined steps (except where context excludes that possibility).

Still further, additional aspects of the instant invention may be found in one or more appendices attached hereto and/or filed herewith, the disclosures of which are incorporated herein by reference as if fully set out at this point.

Thus, the invention is well adapted to carry out the objects and attain the ends and advantages mentioned above as well as those inherent therein. While the inventive concept has been described and illustrated herein by reference to certain illustrative embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

### ADDENDUM

### Background

### SOLAR FARMS

Solar Farms (Solar Parks or Solar Fields) are the large-scale application of solar photovoltaic (PV) panels that generate renewable, clean electricity at scale to feed into the grid. Solar farms can range in size from 1 acre to over 100 acres.

Solar Farms typically are organized rows of interconnected PV panels that generate DC energy that is in turn inverted to AC prior to a supply connection to the main power grid.

Revenue is generated on a contract rate per KWH that has been pre-determined and guaranteed by the utility.

### BROWNFIELDS

A Brownfield is a former industrial or commercial site where future use is affected by real or perceived environmental contamination.

There are as many as 500,000 Brownfields throughout North America comprising a total area estimated to be well over 5 million acres.

Brownfield lands collectively are undervalued by an estimated 2.5 trillion dollars due to the presence of contamination.

Recently the EPA in the U.S. has identified Brownfields as having potential to accommodate solar generation thus minimizing the consumption of greenfields/farmland for this purpose.

### SOIL & GROUNDWATER REMEDIATION

There are many methods by which contaminated soil and groundwater may be remediated. These can be categorized into two main groups however:

Ex-Situ—(Off site) Material removed from site for disposal at another location.

In-Situ (On-site) Soil & Groundwater treated “in place”

Ex-Situ is often discouraged as it is simply involves relocating the problem.

In Situ remedies however have advanced substantially especially as of late and most all remedial efforts now involve, in whole or in part, some in-situ initiatives.

In Situ remediation can be further categorized into three distinct classifications: Chemical; Mechanical; and Biological.

There are also hybrid versions, combining these efforts with one another for increased efficacy and expediency.

In-Situ Remedial measures may include but are not limited to the following:
Soil Vapor Extraction (Mechanical)
Vapor Sparging (Mechanical)
Chemical Oxidation & mobilization (Chemical)
Ozone Production & Oxidization (Mechanical
Bioremediation (Biological)
Bioventing (Mechanical/Biological)
Pump & Treat (Mechanical/Chemical)
Electrokinetic Separation (Mechanical)
Bio-Electrokinetic Remediation (Mechanical/Biological)
Electrochemical Remediation (Mechanical/Chemical

### UNIQUE Process

The invention includes, as one aspect, a unique process by which the large-scale generation of solar power (solar parks, solar farms) may be leveraged in whole or in part for the remedial effort.

A primary function of the solar farm remains the generation of DC power, sold directly or inverted and sold to the local utility. However, according to an embodiment of the invention, a very small part of this generated energy would be redirected at source to the remedial effort.

The Solar Farm in fact supports the soil and groundwater remediation initiative.

In addition, revenue generated by the sale of solar generated energy may subsidize or in many cases offset entirely the costs associated with the soil and groundwater remediation initiative.

### UNIQUE BUSINESS MODEL

According to the inventive process, contaminated sites may now be remediated at the same time that the Brownfield site, inactive due to the presence of contamination, is generating revenue.

From an investment perspective this is ground-breaking as the investor may now reap both a guaranteed fixed return for the solar energy generated as well as realize an even greater return when equity, once suppressed or impacted by the presence of contamination, is returned.

### UNIQUE—SOLAR REMEDIATION NETWORK

A typical solar farm is a plurality of rows of interconnected photovoltaic (PV) panels. These PV panels are fastened to a support substructure that is in turn is anchored to footings or mounted to a ballasted (weighted) base.

According to the invention, rows of solar panels once interconnected only for one-way (power) connectivity are upgraded to provide full two-way communication and in doing so a hard-wired network is created to send or receive information or instructions to any location in the farm.

Remedial infrastructure is located anywhere it may be required in the same organized solar PV rows and is connected to, operating in concert with, the solar generation effort. The solar farm now becomes a fully programmable power generation/remedial network and as such may be programmed to perform a variety of remedial tasks in any location or multiple locations concurrent to one another if necessary.

Forming another aspect of the invention is a unique substructure, not unlike that used to support solar panels. This substructure interconnects wells at various location/spacings that provide access to the contaminated soil and groundwater below at various depths.

This support substructure connects the wells and facilitate the installation of cabling, ventilation, conduit or fluid movement lines that allow all well locations to be easily and inexpensively connected (without burial). It also supports PV panels not unlike conventional solar installations.

Monitoring sensors, wells, pumps, ventilation and assorted remedial equipment may send or receive a variety of instructions, information or commands; Information that may include temperature, PH, toxicity levels etc. as well as data necessary to visualize the subsurface contamination such that the efficacy and extent of the remedial initiative may be monitored and measured. Remedial operations are now fully programmable, passive and conducted with maximum efficiency at one or multiple locations may now work together or in concert with one another.

This is unique since a fully powered programmable environment allows for endless programming/functionality capabilities. Remedial activities in fact become “plug and play” allowing the network to be reprogramed at any time to accommodate a change in remedial strategy.

### UNIQUE—CENTRALIZED & PROGRAMABLE VAPOR EMISSIONS CONTROL

Due to the toxicity of many of the contaminants found on Brownfield sites, vapor emissions from the wells must be controlled. A filtration system connects the wells with the appropriate filtration/treatment media.

Ventilation, conduit or piping also leverage the remedial support substructure connecting the wells and may be controlled via the network capability mentioned earlier.

This allows multiple wells now to share the same vapor emissions control system cost effectively. In addition, this ventilation system may now be programmed in any way including for example whenever a well needs to be pressurized in soil vapor extraction operations.

### UNIQUE—CENTRALIZED & PROGRAMABLE FLUID CONTROL SYSTEM

Once more the supporting sub structure as well as DC power available anywhere needed is leveraged.

Supply lines from a centralized supply point are mounted to the substructure to transport liquids including surfactants, chemical oxidants, supplements, bacteria or groundwater to any one of the wells or to multiple wells on demand.

Additionally, contaminated water from wells may be drawn to a centralized location for treatment (pump & treat) returned or discharged. Wells may also be flooded if required for the distribution of the surfactants, biologicals or supplements or to establish better electro-connectivity.

### UNIQUE—FULL IN-SITU REMEDIATION CAPABILITIES

The aforementioned DC power availability, network communication capabilities, ventilation/vapor control and management and fluid control systems provide for a full range of in-situ remediation possibilities ranging from chemical, mechanical and biological now with increased capabilities, efficacy and expediency.

In-Situ remedial efforts may now include but are not limited to the following:
Soil Vapor Extraction
Soil flushing
Sparging
Chemical Oxidation & mobilization
Ozone Production & Oxidization
Groundwater heating
Advanced Bioremediation
Bioventing
Pump & Treat
Electrokinetic Separation
Bio-Electrokinetic Remediation
Electrochemical Remediation
Nanotechnology

### UNIQUE-HYDROGEN ENERGY BY-PRODUCT

According to another aspect of the invention, electrokinetics (Electrolysis) is used in the remediation effort to provide mobility for a variety of chemical oxidants, surfactants, additives, supplements, and biologicals in addition to mobilizing or degrading heavy metals and other contaminants.

The DC current used in electrolysis splits the water into hydrogen (at the cathode -negative) and oxygen (at the anode-positive). As the wells are part of a controlled environment (ventilation), hydrogen may be harvested and stored.

This hydrogen can be sold or directed to hydrogen generators that can supply clean energy in addition to the solar energy generated during daylight hours only

### UNIQUE—CLEANFIELD™ ENERGY—DC MICROGRID/CHARGING STATION

The demands for DC powered transportation are growing rapidly and with the advent of electric trucks, bus fleets etc., re-charging infrastructure for this next generation of transportation is desperately needed; especially in key urban locations.

Large vehicles have needs for huge volumes of DC power and reduced charging times are critical. DC power directly from source to DC recipient charging is far more efficient than converting AC and charging times are greatly reduced as a result.

Brownfields are typically located in or near urban centers, on primary arterial transportation routes that can accommodate heavy vehicle traffic and in addition most Brownfield sites already have 3 phase power connectivity to the grid where excess power may be supplied or sourced if required. (net metering).

Vehicles of this type can be up to 80 feet in length and weigh as much as 80,000 lbs. Brownfield sites can easily accommodate this type of traffic and with localized power generation, storage and connectivity to the grid, have a huge advantage in both cost and efficiency.

Rather than converting the DC to AC to supply the grid, this DC energy can be produced and used directly or produced and stored on-site and supplied directly.

### SUMMARY

Passive, programmable, cost effective Brownfield remediation is now possible.

The inventive process, which combines remedial initiatives with renewable power generation in a fully programmable network environment, represents a fundamental enhancement capability to existing solar farm/park: it does not simply generate power, it generates power and leverages a small portion of this power at source to remediate contaminated groundwater and soil cost effectively.

The process represents an evolution of the standard remediation model wherein the full in-situ remediation capability is installed from the outset. This infrastructure may be re -programmed at any time allowing for a full range of effective remediation capabilities and, when not in use, supplements the primary DC power generation initiative.

1. A bioremediation method, the method comprising:
locating power generation equipment for generating renewable power on a brownfield site;
remediating at least an area of the brownfield site, using power from the power generation equipment; and
relocating at least a portion of the power generation equipment for the remediation of another area of brownfield.

2. The method of claim 1, wherein the power generation equipment comprises a photovoltaic cell or a windmill.

3. The method of claim 1, wherein the power generation equipment provides power to only a small portion of the brownfield site, and wherein the power is used to power remediation equipment located in the small portion of the brownfield site.

4. The method of claim 1, further comprising:
selling at least a portion of the generated power back to a power grid.

5. The method of claim 1, further comprising:
drilling one or more holes to install a support for the power generation equipment;
wherein the one or more holes is useable as a well for the remediation of the brownfield site.

6. The method of claim 1, wherein monitoring equipment is further connected to the power generation equipment for monitoring efficacy of the remediation over at least the area of the brownfield site.

7. The method of claim 6, further comprising:
monitoring the efficacy of the remediation; and
reprogramming remediation equipment to improve the efficacy of the remediation, based on the monitoring.

8. A bioremediation system, the system comprising:
power generation equipment for generating renewable power located on a brownfield site; and
remediation equipment for remediating at least an area of the brownfield site, the remediation equipment using power from the power generation equipment for performing the remediating.

9. The system of claim 8, wherein the power generation equipment comprises a photovoltaic cell or a windmill.

10. The system of claim 8, wherein the power generation equipment provides power to only a small portion of the brownfield site, and wherein the remediation equipment is located in the small portion of the brownfield site.

11. The system of claim 8, wherein the power generation equipment is further connected to a power grid to sell at least a portion of the generated power back to the power grid.

12. The system of claim 8, wherein one or more holes for installing a support for the power generation equipment is also useable as a well for the remediation of the brownfield site.

13. The system of claim 8, further comprising monitoring equipment connected to the power generation equipment for monitoring efficacy of the remediation over at least the area of the brownfield site.
